(19) United States
(12) Patent Application Publication
(10) Pub. No.: US 2016/0371767 A1
(43) Pub. Date: Dec. 22, 2016

(54) PURCHASE AND DONATION BOX AND SYSTEM

(71) Applicant: Monika Wiela, Los Angeles, CA (US)

(72) Inventor: Monika Wiela, Los Angeles, CA (US)

(21) Appl. No.: 15/254,928

(22) Filed: Sep. 1, 2016

Related U.S. Application Data
(63) Continuation-in-part of application No. 14/027,948, filed on Sep. 16, 2013, now abandoned.

(51) Int. Cl. G06Q 30/06; G06Q 10/08

(52) U.S. Cl. CPC G06Q 30/0641; G06Q 10/083

(57) ABSTRACT

A purchase and donation box system for donating pre-owned items through online shopping, in which a shopper can choose to donate items to a charity selected from a charity database while shopping online. A shipping label for the charity is generated, and sent to the shopper with the online purchase in a shipping box. After receiving and unpacking the box, the shopper uses the charity shipping label to send the donation in the same shipping box to the charity. The donation is recorded in the charity database, and the shopper is optionally provided a list of all donations from the charity database at the end of the calendar year.

### CROSS-REFERENCE TO RELATED APPLICATION

This application is a continuation-in-part application (CIP) of U.S. patent application Ser. No. 14/027,948, filed Sep. 16, 2013, which claims priority to U.S. Provisional Patent Application Ser. No. 61/701,295, filed Sep. 14, 2012, both of which are incorporated herein by reference as if fully recited herein.

### TECHNICAL FIELD

The present invention relates to a system and methods for providing donations of articles to charities by sending pre-owned articles to charities in a box that was received from an online shopping purchase. The present invention also relates to a computer-implemented method of purchasing items and donating items by a user.

### BACKGROUND

Online or internet shopping allows a shopper or purchaser to readily select and purchase items, which are typically shipped to the shopper at a specified address in a box after the online purchase transaction is completed. Upon receipt of the box and removal of the purchased items, the shopper has a box, which may be empty or contain packaging materials, to dispose of or use in another manner. The box may be used for subsequent shipping of other items, storage of goods, etc. The potential use of the box or its disposal is at the discretion of the shopper, and it is not related to the online purchase.

Upon obtaining the items purchased online, the shopper typically has less room in a closet. The shopper at some convenient time selects and carries donated clothing and other articles to a local charity drop-off. Monetary donations can be made online.

### BRIEF DESCRIPTION OF THE DRAWINGS

For a further understanding of the objects and advantages of the present invention, reference should be had to the following detailed description, taken in conjunction with the accompanying drawing, in which like parts are given like reference numbers and wherein:

FIG. 1 shows a process for opting to donate while shopping online;

FIG. 2 shows a process for shipping a box to a shopper;

FIG. 3 shows a process for receiving a box from an online purchase and subsequently using the box to make a donation;

FIG. 4 shows a process for obtaining a tax deduction for a donation; and

FIG. 5 shows a computer-implemented method in accordance with the purchase and donation system.

### DETAILED DESCRIPTION

The present invention is directed to a system that provides online shoppers with the option to donate pre-owned items to charities or individuals in conjunction with online shopping. Online shopping currently does not provide an opportunity for the shopper to donate to charity pre-owned items that the shopper no longer needs or desires as part of the online shopping experience. That is, there are no online shopping sites configured to give donations of pre-owned items as part of the online shopping and receiving of purchased items process. Online shoppers consequently end up with a shipping box (and, typically, packing materials) to dispose of, and they may also accumulate items no longer wanted. The online shopper therefore has to subsequently donate items, which is time consuming and can be problematic in that the shopper has to find a charity or individual to donate to, and frequently incurs expense of delivering or shipping the donated item(s) to the charity.

The purchase donation box and system described herein advantageously provides an end-to-end supply chain concept in which the online store ships purchased items in a box to the shopper, and the shopper in turn uses the same box to donate to charity his or her used or unused household or closet items the shopper no longer needs or wants. This ecofriendly system eliminates time consumed by the donor in donating to charities, and increases the ability or ease of a shopper/donor to donate to charity. The increased ease of donating to charity provides the shopper with the ability to better manage the shopper's wardrobe, closet, or household goods through readily donating items that the shopper might otherwise accumulate when the items are no longer needed or desired. The donation system also reduces the cost of acquisition of obtaining donations by charities, since the donations are conveniently shipped directly to the charity. A further advantage of the donation system is that it coordinates tax deduction information from the donation for the shopper, and thereby helps facilitate claiming of the deduction on a tax return.

Briefly, the system entails providing a process to a person (shopper or purchaser) for opting to donate while shopping online, a process for shipping a box with a purchased item(s) and a prepaid charity label to the shopper, a process for the shopper to receive the box and subsequently use it to ship a donation to a charity, and optionally, a process for obtaining a tax deduction for the donation.

While the invention as described herein refers to a preferred embodiment of a shipping “box,” it will be recognized that the invention can be practiced with any type of commercially used shipping container. For example, without limitation, such containers can include reusable shipping bags or shipping tubes.

One aspect of the invention is a central online donation and charity database. This database is maintained on a server and is accessible by remote users through a web based interface or site. The charity database will store information for charities and charitable individuals that includes details of the charity, such as name, location/address, phone number, tax identification number, etc. Charities and individuals will have access to the database and submit the charity information to the charity database. Online stores will likewise have access to the charity database, and each online store will have an interface with the charity database on the store's online shopping site, so that the shopper will be able to select donating to a charity and be able to select or designate the charity which will receive the donation. The charity database will also be configured in conjunction with the online store's shopping site to allow for auto selection of a charity by the charity database, should the shopper not designate a particular charity. The charity database will also store records of all donations made by shoppers through the online donation system. Information from these records will be subsequently provided to shoppers for the purpose of claiming tax deductions.

For the purposes of promoting an understanding of the principles of the invention, reference will now be made to the exemplary embodiments illustrated in the drawings, and specific language will be used to describe the same. It will nevertheless be understood that no limitation of the scope of the invention is hereby intended. Any alterations and further modifications of the inventive features illustrated herein, and any additional application of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus appearances of the phrases an “embodiment,” and “example, “and similar language throughout this specification may, but do not necessarily, all refer to the same embodiment, to different embodiments, or to one or more of the figures. Additionally, reference to the words “embodiment.” “Example” or the like for two or more features, elements, etc., does not mean that the features are necessarily related, dissimilar, the same, etc.

Each statement of an embodiment or example is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional un-recited elements or method steps. “Comprising” is to be interpreted broadly and including the more restrictive terms “consisting of” and “consisting essentially of.”

Reference throughout this specification to features, advantages, or similar language does not imply that all of features and advantages that may be realized with the present invention should be or are in any single embodiment of the invention. Rather, language referring to the features and advantages is understood to mean that a specific feature, advantage or characteristic described in connection with an embodiment is included in at least one embodiment of the present invention. Thus, discussion of the features and advantages, and similar language, throughout this specification may, but does not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description or may be learned by the practice of the invention as set forth.

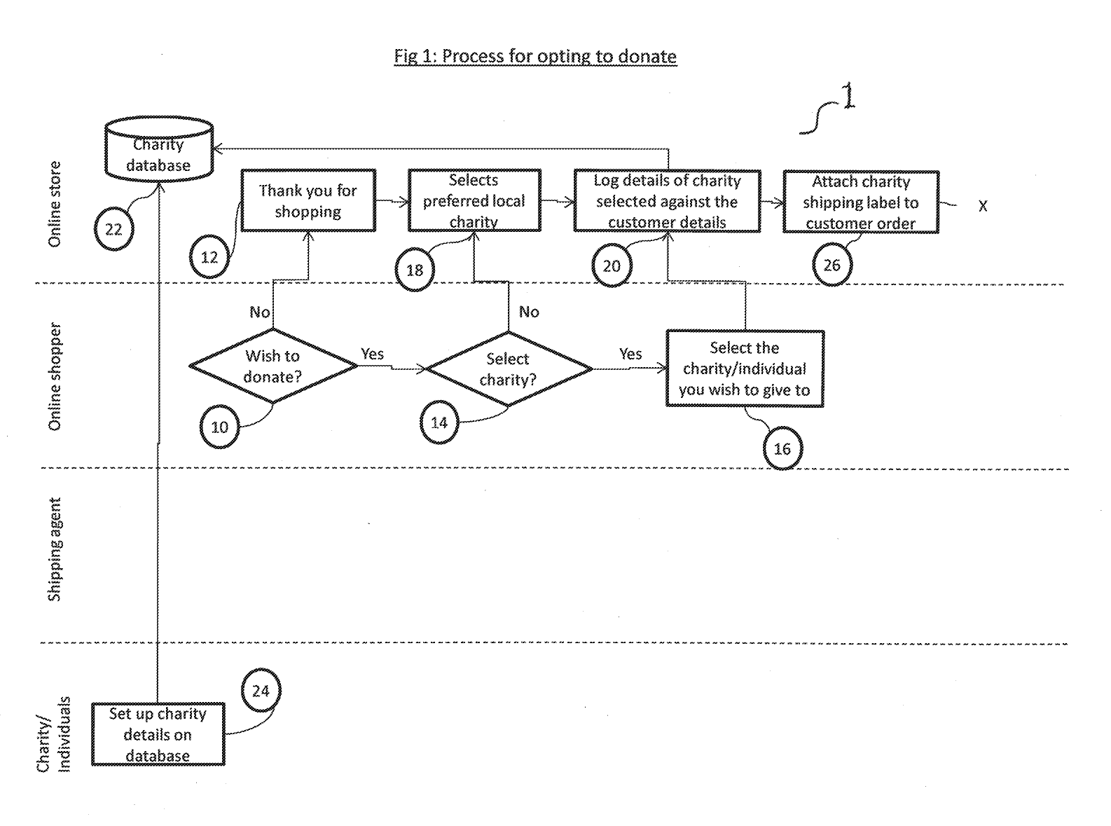

Referring to FIGS. 1-4, the system of the present invention is illustrated and described in exemplary flowcharts. Turning to FIG. 1, when a person or shopper/user shops online at an online store or shopping site and has completed his or her purchase of the item(s) in the shopping transaction, the shopper is given the option of donating used and unused items to charity 10. These items are ones the shopper currently owns and no longer needs or desires, and which would readily fit inside the shipping box or container in which the shopper receives the online purchased item(s). For example, the items can be shoes, garments, accessories, or other items the person may wish to donate. If the shopper chooses “no,” the online shopping transaction is completed 12. Should the shopper choose to donate an item(s), he or she will be presented with the online option of selecting a charity 14. This online option will be executed from the same shopping site through which the person made a purchase. If the person does not select a charity, the online store auto-select a preferred charity 18, which preferably is local to at least the state (in the U.S.) of the shopper, if not the city or greater municipal area of the shopper. Should the shopper choose to select a charity, the shopper is presented with options for the charity which is to receive the donation 16. The charity is selected from a charity database 22 to which charity organizations or individuals have provided charity details 24 for the online charity database. Upon selection of a charity, either by auto selection or the shopper, the shopper's online transaction is completed.

In the event the shopper/donor wishes to select a charity that is not listed in the charity database 22, the shopper may be presented with the option of entering the shopper's charity of choice. In this aspect, the shopper will not select from a preselected list of charities, but instead will enter the details of the charity in the online charity database when opting to donate during the initial online shopping transaction. Based on the information submitted to the charity database by the shopper, the charity can be verified by a query sent from the charity database system to the charity.

The online shopping store records the details of the charity selected from the charity database 22 against the shopper/customer details 20, such as the order number, name, date, etc. The online store then attaches details for a shipping label for the charity to the customer's order 26.

The details, such as name, contact, address, etc., for the charity recipient of the gift/donation are stored on the online system charity database 22, which has a list of charities or individuals seeking donations. The details to the charity database are supplied by the charitable organizations and individuals 24. The appropriate details for shipping the donation (charity name, address, etc.) are printed out for the preprinted shipping label. This charity shipping label is in addition to the shipping label printed for shopper's own shipping address.

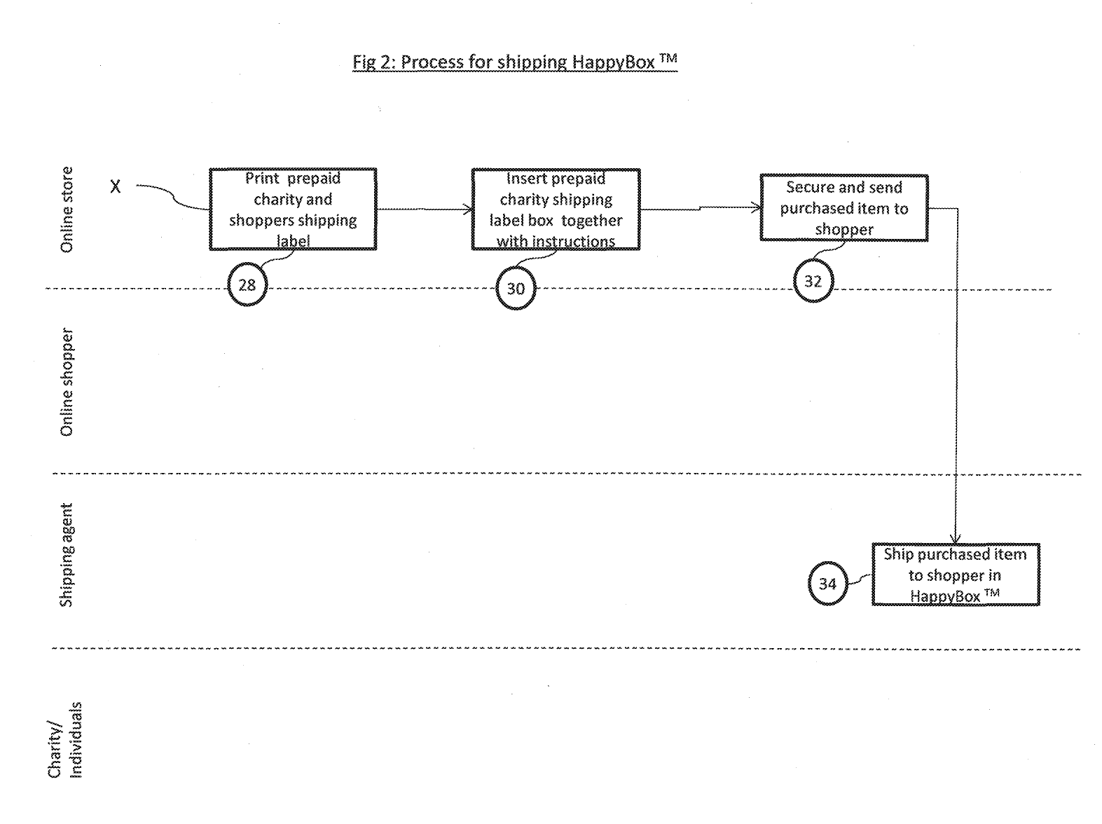

After the online store has attached the charity shipping label to the customer's order 26, the online store prints the customer's shipping label as well as a prepaid charity shipping label to be included with the order 28 (FIG. 2). The online store packs the items the customer has ordered, the preprinted shipping label for the selected charity, and instructions into a shipping box (such as the commercially available HappyBox™) or container 30. The instructions direct the customer how to process the donation after the customer has opened the box and received the item(s) the customer ordered. The box is secured shut, a shipping label to the customer is attached, and the box is sent to the customer 32. The box typically is shipped from the online store to the customer by a shipping agent or commercial shipper such as Federal Express, United Parcel Service, United States Postal Service, or others 34.

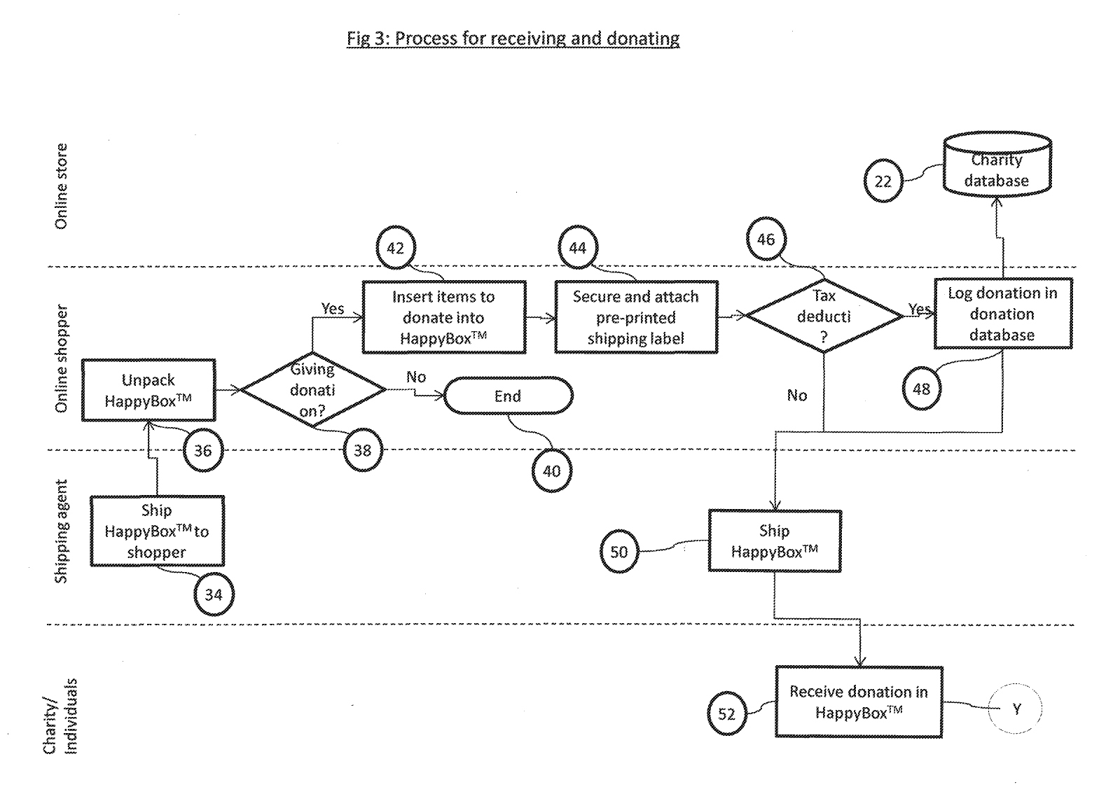

Referring to FIG. 3, after the online shopper has received the box with the purchased item(s), instructions and preprinted charity label, the shopper takes out the item(s) purchased from the online store 36. The shopper then has the option to proceed to donate items 38. If the shopper so chooses, the shopper may put into the box or shipping container an item(s) to be donated to the charity which was personally selected or auto selected during the online purchase 42. Such items include, but are not limited to, items such as those from a closet or elsewhere in the household that the shopper wishes to donate to the charity. After placing the item(s) into the box, the box is secured and the preprinted shipping label for the charity, which was sent inside the box with the order, is attached to the outside of the box 44.

The instructions include, but are not limited to, asking if a tax deduction is required or desired by the shopper 46. If a tax deduction is desired, the shopper logs onto an online donations system 48 associated with the charity database 22. The shopper logs or registers the items donated to the charity 48. In a preferred embodiment, the registration of the items to be donated utilizes a code on the shipping label (typically, the shipping label code), which associates the shopper with the donation, thereby designating the shopper (donor) to the charity. After the donation has been registered for tax deduction 48, or after the tax deduction was declined 46, the box is then taken to a commercial shipper such as Federal Express, United Parcel Service, United States Postal Service, or others to be shipped to the charity 50. The charity then receives the donation in the box 52.

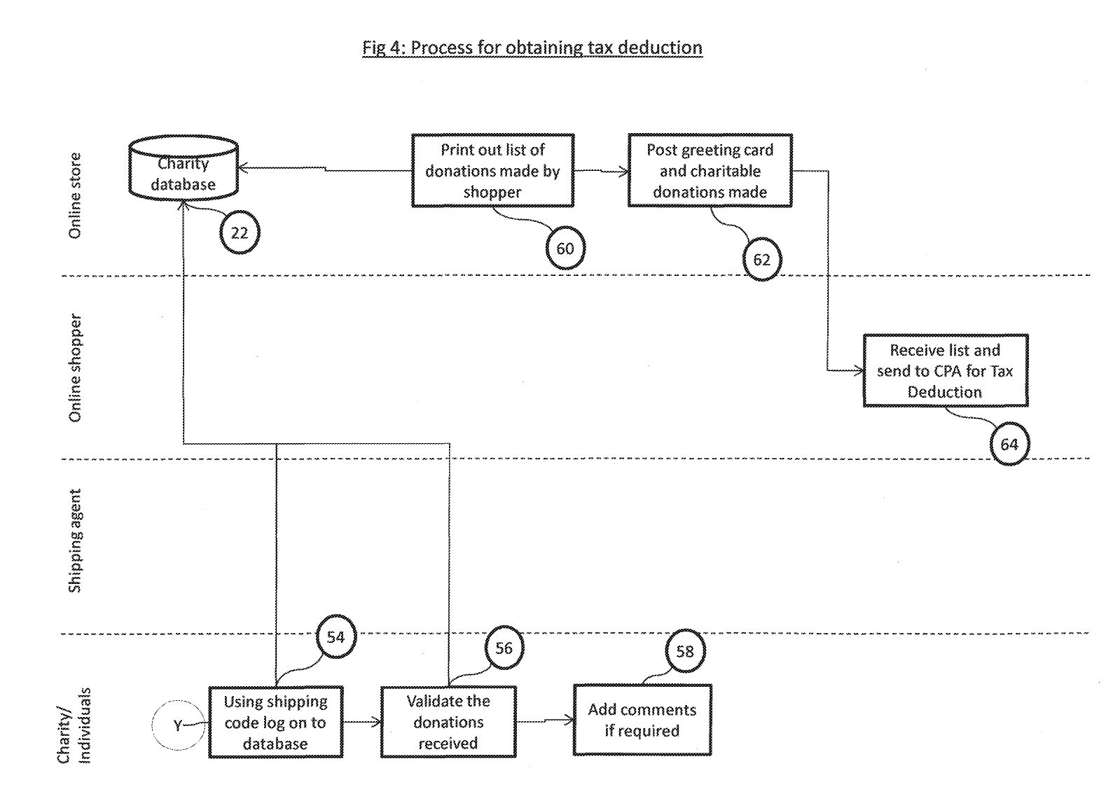

After the charitable organization or individual receives the donation, the charity is able to confirm receipt of the donation for the donor's tax deduction. The charity logs on to the online donations/charity data base, using information on the shipping label 54 (FIG. 4). In a preferred embodiment, this information is the shipping code. The charity then validates the donation(s) received from the donor 56, and adds any additional comments that may be required with the validation 58. The validated donation is then contained in the charity database 22. At the end of the calendar year or shortly thereafter (i.e., early in the new year), information stored in the charity database 22 is used to provide or print out lists of donations made by shoppers through the online donation and box system 60. The lists can then be sent to all shoppers to thank them and acknowledge their donations 62. The shoppers can be sent a list of their donations, either by hard copy or electronically (such as email). In one embodiment, the shoppers are sent a greeting or post card that includes the list of charitable donations. After receiving the list, the shopper subsequently uses the donation information to claim a tax deduction for the donations upon filing of the shopper's tax return 64.

In an alternate embodiment, a shopper chooses to not donate initially during the online shopping transaction 12, but then subsequently decides to donate, such as when the shopper receives the box of items purchased from the online store. In this situation, the shopper logs onto the online donation system and elects to donate. Preferably, the shopper logs onto the system using the invoice number or other unique identifier from the online transaction. The online donation system then provides the shopper with instructions for donating items 42, and allows the shopper to print a shipping label or instructs the online store to generate a shipping label and send it to the shopper, preferably by email, which can contain the shipping label or a URL at which the shopper can get the shipping label. The shopper can then print off the label and then attach it to the box 44, and complete the donation process.

As described above, the charity logs the donation into the charity database toward the shopper obtaining a tax donation 54. Alternatively, the charity acknowledges receipt of the donation by notifying the shopper directly, such as by email or traditional mail, rather than through the online donation system. In this embodiment, the direct notification from the charity provides the shopper with the record of donation for tax deduction purpose.

While the online donation process described above readily facilitates the process of donating to a selected charity, the online shopper may wish to donate items without specifying the charity online. In this aspect of the present invention, the shopper can be presented with a check or tick box while shopping online to indicate the desire to donate to charity, without specifying a charity, and the shipping company selects a charity. The shopper is then be sent a shipping coupon or optionally a voucher, either electronically or with the purchased items. The coupon or voucher is suitable for use at a shipping agent or commercial shipper such as Federal Express, United Parcel Service, United States Postal Service, etc., to generate a shipping label. The shopper then uses the label with the received box or container from the online purchase to ship a donation to the shopper's charity of choice.

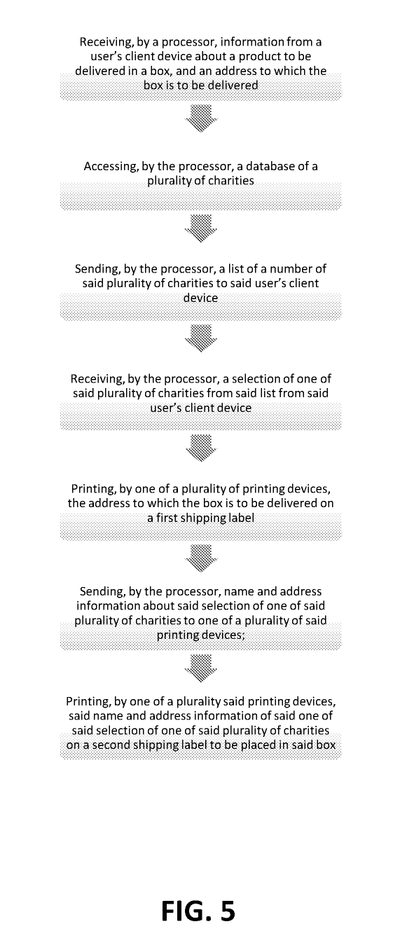

The systems and processes described herein can be achieved by computer-implemented methods using a processor to execute the various steps. An exemplary computer-implemented method can be seen in FIG. 5. In this example, a processor receives information from a user's client device about a product that has been selected for purchase. The selected product is to be delivered in a shipping box or other appropriate shipping vessel. Along with the information about the product being purchased, the address to which the product and the box is received by the processor. Once the selection of the product to be purchased has been made, a database of a plurality of charities stored in a database is accessed by the processor. A list of the plurality of charities (a select number or all) are sent to the user's client device for selection by the user. The selection is then sent to the processor and received. A first shipping label is created for the address to which the box is to be sent and a second shipping label is created for the box to be sent to the charity. The second shipping label is printed using the name and address of the charity stored in the database. It would be understood that these steps would not necessarily need to be in the order shown in FIG. 5.

Although specific embodiments have been illustrated and described herein, those of ordinary skill in the art will appreciate that any arrangement calculated to achieve same purposes can be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

In the foregoing description, if various features are grouped together in a single embodiment for the purpose of streamlining the disclosure, this method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims, and such other claims as may later be added, are hereby incorporated into the description of the embodiments of the invention, with each claim standing on its own as a separate preferred embodiment.

1. A computer-implemented method of purchasing items and donating items by a user, the method comprising:
receiving, by a processor, information from a user's client device about a product to be delivered in a box, and an address to which the box is to be delivered;
accessing, by the processor, a database of a plurality of charities;
sending, by the processor, a list of a number of said plurality of charities to said user's client device;
receiving, by the processor, a selection of one of said plurality of charities from said list from said user's client device;
printing, by one of a plurality of printing devices, the address to which the box is to be delivered on a first shipping label; and
sending, by the processor, name and address information about said selection of one of said plurality of charities to one of a plurality of said printing devices; and
printing, by one of a plurality said printing devices, said name and address information of said one of said selection of one of said plurality of charities on a second shipping label to be placed in said box.
